(19) United States
(12) Patent Application Publication
(10) Pub. No.: US 2012/0127621 A1
(43) Pub. Date: May 24, 2012

(54) CIRCUIT PROTECTION APPARATUS FOR PHOTOVOLTAIC POWER GENERATION SYSTEMS

(75) Inventors: Edward J. Knapp, JR., Stratham, NH (US); Kevin M. Horne, Gloucester, MA (US)

(73) Assignee: Mersen USA Newburyport-MA, LLC

(21) Appl. No.: 12/952,343

(22) Filed: Nov. 23, 2010

(51) Int. Cl. H02H 3/027

(52) U.S. Cl. 361/94

(57) ABSTRACT

A circuit protection device suitable for use with a photovoltaic power generation system. The circuit protection device includes an electronic control unit and a dual path fuse. The dual path fuse has a first current path defined by a main conductor and a second current path defined by a fuse element. In response to an overcurrent condition, the control unit activates the dual path fuse to open the first current path, thereby shunting current to the second current path. Residual follow-on current flows through the fuse element via the second current path until the fuse element melts. The control unit is programmable with multiple threshold current levels and associated time delays in order to provide different activation response times that are dependent upon the detected current level.

### FIELD OF THE INVENTION

The present invention relates generally to circuit protection apparatus, and more particularly to a circuit protection device suitable for use with a photovoltaic power generation system.

### BACKGROUND OF THE INVENTION

The technology for solar photovoltaic (PV) systems has been rapidly evolving in recent years. Moreover, PV systems are receiving greater acceptance as a cost-effective and clean alternative to conventional energy sources. As the installations and demand for PV systems increase there has been a greater need for effective electrical protection of equipment and conductors.

Solar power generation systems are comprised of photovoltaic cells and power inverters. The photovoltaic cells utilize the power of sunlight to convert photons to direct current (DC) electricity. The electricity generated by the solar cells is then fed into a power inverter that converts and regulates the DC source into usable alternating current (AC) power. The AC power can then be used locally for specific remote equipment, residential homes or fed directly back into the power grid and used as environmentally clean energy. The voltage output of a solar panel is defined by the number of individual photovoltaic cells comprising the solar panel. Currently, solar power generation systems are being designed for higher voltages (e.g., 1000 VDC and above).

In view of the current developments in the area of PV generation systems, there is a need for a circuit protection device that can reliably protect system components (e.g. equipment, conductors, cables, etc.) in high power DC photovoltaic applications at voltages of 1300 VDC or more, and over a wide range of fault currents.

The present invention provides a circuit protection device that addresses deficiencies of existing circuit protection devices, and provides features that are well suited for used with a PV power generation system.

### SUMMARY OF THE INVENTION

In accordance with the present invention, there is provided a circuit protection device comprising a dual path fuse including a main conductor defining a first current path and a fuse element defining a second current path, a power disconnect device for severing the main conductor to open the first current path, thereby shunting residual follow-on current to the second current path until the fuse element melts, and a control unit responsive to an overcurrent condition of a detected current to activate the power disconnect device to sever to the main conductor. The control unit is programmable with operating zone data that provides different response times for activation of the power disconnect device depending upon a level of the detected current.

In accordance with another aspect of the present invention, there is provided a dual path fuse comprising a main conductor defining a first current path, a fuse element defining a second current path, and a power disconnect device responsive to an activation signal to sever the main conductor and thereby open the first current path. The power disconnect device receives the activation signal from a control unit that responds to an overcurrent condition of a detected current. The control unit is programmable with operating zone data that provides different delay times for generating the activation signal depending upon a level of the detected current.

In accordance with still another aspect of the present invention, there is provided a method for protecting a circuit from an overcurrent condition by activation of a circuit protection device that opens a circuit path in said circuit. The method includes the steps of: establishing a plurality of threshold current levels defining multiple current level ranges; establishing a plurality of activation time delays respectively associated with the multiple current level ranges; monitoring a detected current in the circuit; determining whether the detected current is at a current level within one of said multiple current level ranges; activating the circuit protection device to open the circuit path of said circuit if the detected current level is at the current level within one of said multiple current level ranges for a period of time that is equal to or greater than the activation time delay associated therewith.

An advantage of the present invention is the provision of a circuit protection device that can interrupt high voltages (e.g., 1000VDC to 1300VDC) under high power photovoltaic installation conditions.

Another advantage of the present invention is the provision of a circuit protection device that can reliably protect components in high power DC photovoltaic applications over a wide range of fault currents.

Another advantage of the present invention is the provision of a circuit protection device that has a programmable time-current response.

Still another advantage of the present invention is the provision of a circuit protection device that exhibits low power loss.

Yet another advantage of the present invention is the provision of a method for protecting a circuit from an overcurrent condition by activation of a circuit protection device.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a perspective view of a circuit protection device according to an embodiment of the present invention;

FIG. 2 is a partially sectioned front plan view of the circuit protection device shown in FIG. 1;

FIG. 3 is a is a partially sectioned rear plan view of the circuit protection device shown in FIG. 1;

FIG. 4 is a partially sectioned top plan view of the circuit protection device shown in FIG. 1;

FIG. 5 is a schematic block diagram showing the circuit protection device in a circuit with a load;

FIG. 6 is schematic block diagram of a control unit of the circuit protection device, according to an embodiment of the present invention;

FIG. 7A is a schematic block diagram of a first exemplary circuit including the circuit protection device of the present invention;

FIG. 7B is a schematic block diagram of a second exemplary circuit including the circuit protection device of the present invention;

FIG. 7C is a schematic block diagram of a third exemplary circuit including the circuit protection device of the present invention; and

FIG. 8 is a time-current response curve for a circuit protection device according to an embodiment of the present invention.

### DETAILED DESCRIPTION OF THE INVENTION

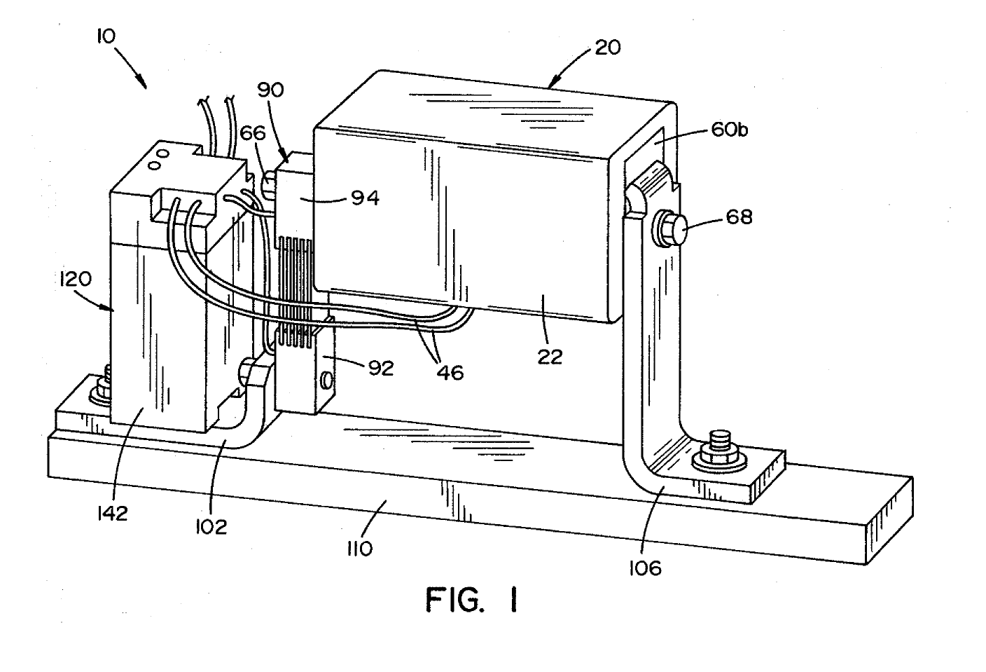

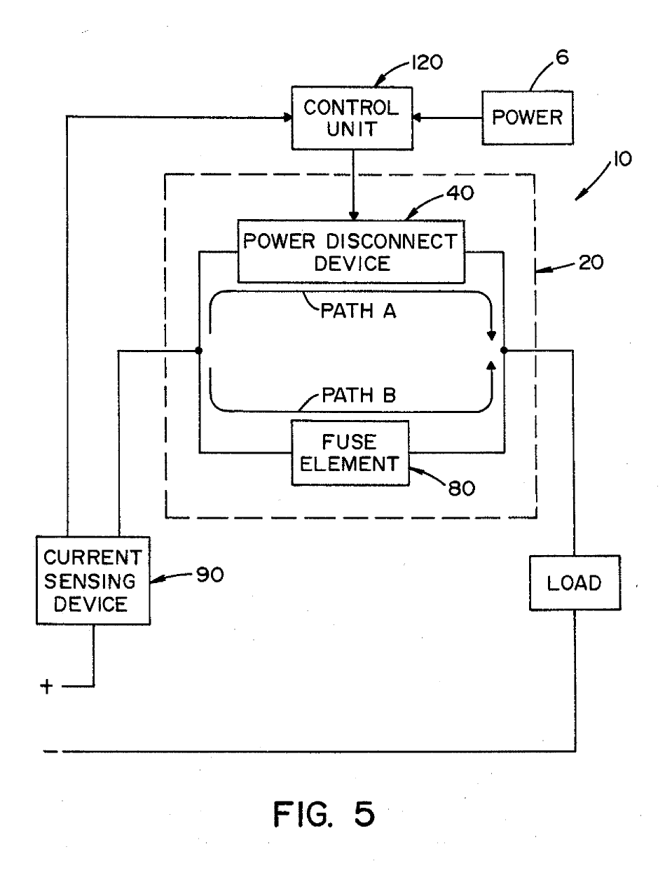

Referring now to the drawings wherein the showings are for the purposes of illustrating an embodiment of the invention only and not for the purposes of limiting same, FIGS. 1-5 illustrate a circuit protection device 10 according to an embodiment of the present invention. FIGS. 1-4 show a mechanical structure of circuit protection device 10, while FIG. 5 shows a schematic block diagram of circuit protection device 10. It should be understood that the mechanical structure of FIGS. 1-4 is shown for the purpose of illustrating an embodiment of the present invention, and is not intended to limit the scope thereof In this regard, it is contemplated that the mechanical structure of circuit protection device 10 may take alternative forms to the illustrated mechanical structure.

Circuit protection device 10 is generally comprised of a dual path fuse 20, a current sensing device 90, first and second copper bus bars or bussings 102, 106, and a control unit 120. In the illustrated embodiment, circuit protection device 10 is mounted to an insulating base unit 110 which is mounted in equipment, and connects to the circuit or device being protected by circuit protection device 10.

Dual path fuse 20 includes a power disconnect device 40, a shunt fuse element 80, a pair of T-shaped conductive terminals 60a and 60b, and a housing member 22. Housing member 22 is preferably made of a conventional insulating material. It is contemplated that dual path fuse 20 may be a replaceable component, thereby allowing re-use of circuit protection device 10.

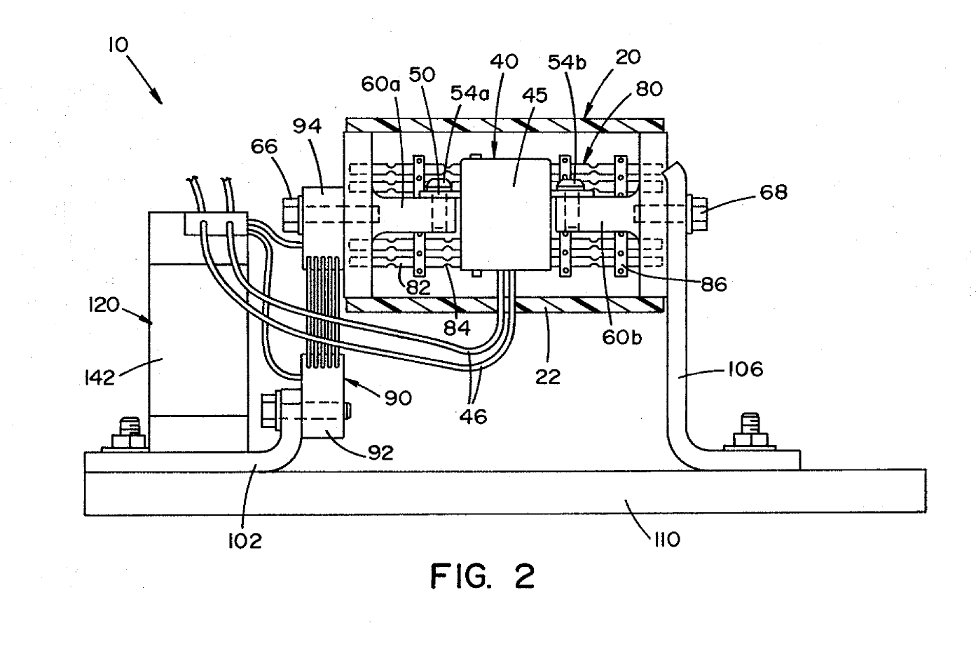

Referring to FIGS. 2-5, dual path fuse 20 will now be described in detail. In the illustrated embodiment, power disconnect device 40 includes a pyrotechnic unit 45 and a heavy conductor strip 50. Conductor strip 50 serves as the main conductor of dual path fuse 20. In one embodiment, conductor strip 50 is a copper bar comprised of a center section having a cross-sectional area of 0.0147 square inches (0.258 inch×0.057 inch) and lateral sections (at opposite sides of the center section) having a cross-sectional area of 0.0627 square inches (1.1 inch×0.057 inch). The reduced center section is where pyrotechnic unit 45 severs conductor strip 50, as described below.

Pyrotechnic unit 45 is comprised of an explosive charge igniter (not shown) and a piston (not shown) for severing the conductor strip 50. In this regard, the explosive charge igniter drives movement of the piston, thereby severing conductor strip 50. Connector leads 46 electrically connect pyrotechnic unit 45 with control unit 120. Control unit 120 activates pyrotechnic unit 45 of power disconnect device 40 to sever the conductor strip 50 in response to an overcurrent condition (i.e., the current flowing through dual path fuse 20 exceeds a threshold current level), as will be described in detail below. A suitable power disconnect device 40 is available from Special Devices, Inc. (SDI) of Moorpark, Calif. See also U.S. Pat. Nos. 7,123,124 and 7,239,225 assigned to Special Devices, Inc. It is also contemplated that power disconnect device 40 may take a forth of a device wherein an alternative technology is substituted for the pyrotechnics, including, but not limited to, an exothermic or chemical reaction.

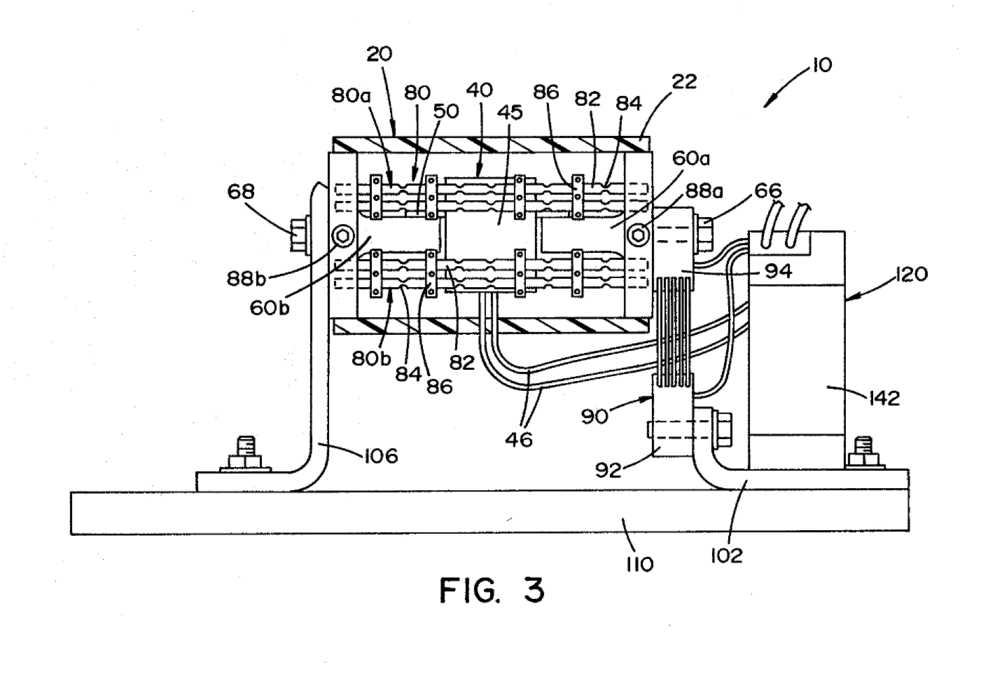

As illustrated, fuse element 80 takes the form of a pair of conducting elements 80a and 80b. As best seen in FIG. 3, each conducting element 80a, 80b is comprised of a plurality of elongated strips 82 having notches 84 formed therein, and a plurality of connecting members 86 that join multiple strips 82. In one embodiment, fuse element 80 is made of copper with tin plating.

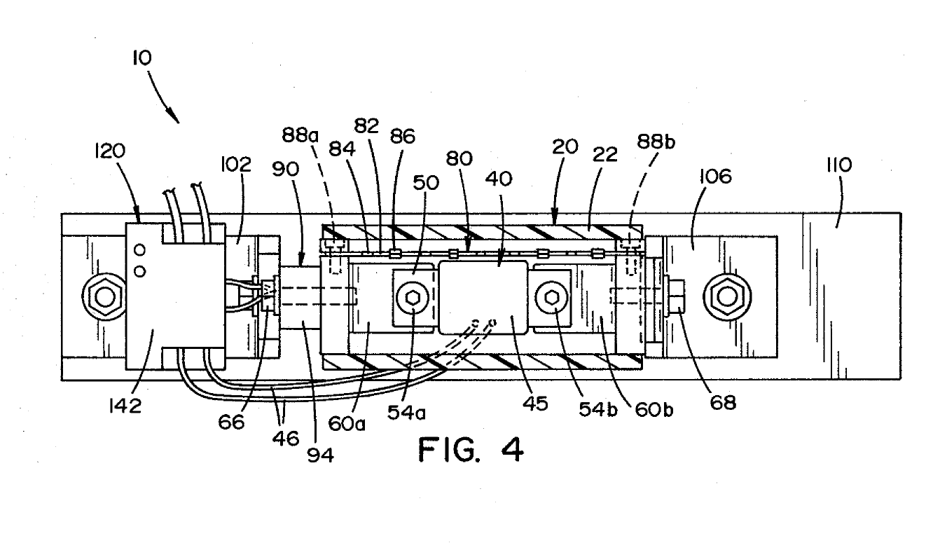

As best seen in FIG. 4, conductor strip 50 is joined to conductive terminals 60a and 60b by respective fasteners 54a and 54b. Conductor strip 50 defines a first current path (A) through dual path fuse 20. Fuse element 80 is joined to conductive terminals 60a and 60b by respective fasteners 88a and 88b. Fuse element 80 defines a second current path (B) through dual path fuse 20. As shown in the schematic of FIG. 5, current paths (A) and (B) are parallel current paths. In the illustrated embodiment, fasteners 54a, 54b and fasteners 88a, 88b take the form of threaded bolts that are dimensioned to be received by threaded bolt holes formed in conductive terminals 60a and 60b. Dual path fuse 20 is preferably designed to operate over a broad range of currents, e.g., 100 Amps to over 10,000 Amps, well up into the short circuit range.

In the illustrated embodiment, housing member 22 takes the form of an insulating tube. Housing member 22 supports the two conductive terminals 60a, 60b and encloses power disconnect device 40 and fuse element 80. Empty space within housing member 22 is preferably filled with silica sand (not shown).

Current sensing device 90 may take many different forms, including, but not limited to, a current shunt resistor (e.g., rated at 400 A/100 mV) or a Hall Effect current sensor (e.g., a CSN Series closed loop current sensor from Honeywell, such as model no. CSNJ481-001, rated at 600 A). A current shunt resistor is a low resistance precision resistor that measures AC or DC electrical currents by the voltage drop an AC or DC electrical current creates across the shunt resistor. In this regard, the voltage across the current shunt resistor is proportional to the current through the current shunt resistor. A Hall Effect current sensor represents a low power loss alternative to a current shunt resistor. The Hall Effect current sensor is not directly connected to the current path. In this regard, the current carrying conductor passes through the Hall Effect current sensor assembly. It is noted that a Hall Effect current sensor requires a power source for operation, while a current shunt resistor does not require a power source.

First copper bussing 102, current sensing device 90, dual path fuse 20 and second copper bussing 106 are electrically connected in series, as best seen in FIGS. 1-3. In the illustrated embodiment, the first end of first copper bussing 102 is fastened to base unit 110 by a metal bolt and nut. The second end of first copper bussing 102 is fastened to first end 92 of current sensing device 90 by a metal fastener. Second end 94 of current sensing device 90 is fastened to conductive terminal 60a by metal fastener 66. In the illustrated embodiment, fastener 66 is a threaded bolt dimensioned to be received by a threaded bolt hole formed in conductive terminal 60a. The first end of second copper bussing 106 is fastened to base unit 110 by a metal bolt and nut. The second end of second copper bussing 106 is fastened to conductive terminal 60b by metal fastener 68. In the illustrated embodiment, fastener 68 is a threaded bolt dimensioned to be received by a threaded bolt hole formed in conductive terminal 60b. As mentioned above, one of the objectives of the present invention is to provide a circuit protection device that has low power loss, yet is able to interrupt currents at high voltages. In order to minimize power loss, it is recognized that the lengths of first and second copper bussings 102 and 106 should be minimized while the cross-sections should be maximized.

Control unit 120 is comprised of electrical components (described below) that are located within a housing member 142. For the purpose of illustrating an embodiment of the present invention, control unit 120 is shown mounted on copper bussing 102. However, it should be appreciated that control unit 120 may also be mounted directly on base unit 110 or located in alternative locations that are remote from dual path fuse 20. One function of control unit is to activate dual path fuse 20 in response to an overcurrent condition. As will be described in detail below, control unit 120 uses current sensing device 90 to monitor the current flowing through dual path fuse 20. In response to an overcurrent condition, control unit 120 activates power disconnect device 40 of dual path fuse 20 to open the first current path (A), thereby shunting current to the second current path (B) defined by fuse element 80. Residual follow-on current flows through fuse element 80 until fuse element 80 melts.

A power source 6 (not shown in FIGS. 1-4) provides power to control unit 120 and power disconnect device 40. In the illustrated embodiment, power source 6 is preferably a DC power source, such as an external DC power supply or a battery having a voltage in the range of 9.6V to 84V. It is contemplated that the battery may be a component of circuit protection device 10.

With reference to FIG. 5, there is shown a schematic block diagram of circuit protection device 10 connected with a load. As described above, circuit protection device 10 includes dual path fuse 20 (comprised of power disconnect device 40 and fuse element 80), current sensing device 90, and control unit 120. As indicated above, circuit protection device 10 may also include power source 6.

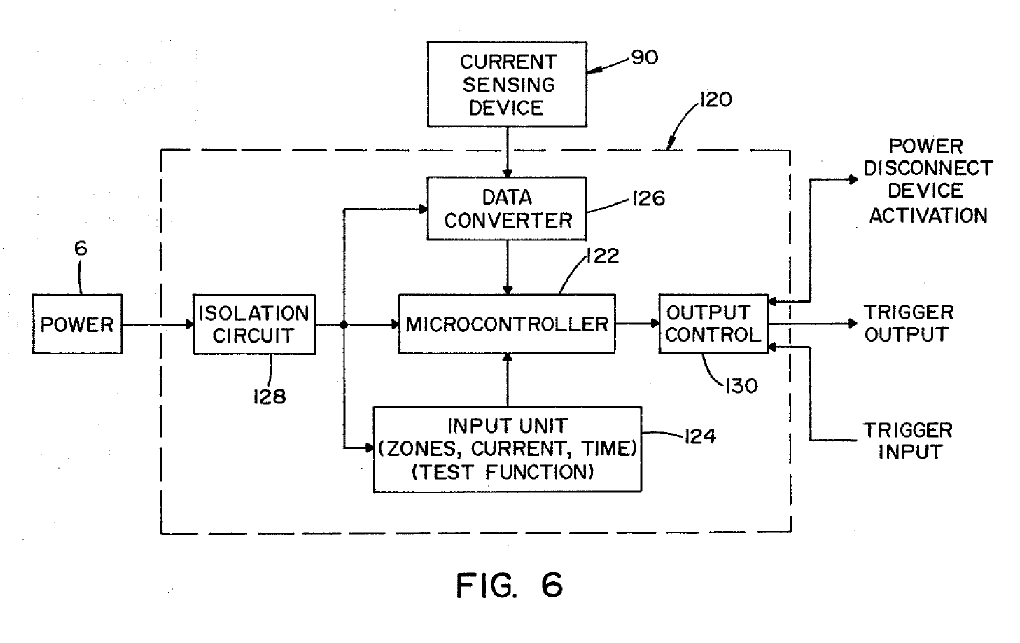

Control unit 120 will now be described in detail with reference to the schematic block diagram shown in FIG. 6. According to one embodiment of the present invention, control unit 120 is generally comprised of a microcontroller 122, an input unit 124, a data converter 126, an isolation circuit 128 and an output control 130. It should be understood that the schematic block diagram of control unit 120 of FIG. 6 is shown for the purpose of illustrating an embodiment of the present invention, and is not intended to limit the scope thereof. In this regard, it is contemplated that control unit 120 may take alternative forms to the block diagram shown in FIG. 6. For example, microcontroller 122 may be replaced with a customized logic circuit.

Microcontroller 122 is a programmable processing unit that is in communication with input unit 124, data converter 126, and output control 130. Power to microcontroller 122 is provided by power source 6 via isolation circuit 128. The function of isolation circuit 128 is to isolate microcontroller 122 from power source 6. In this regard, isolation circuit 128 may include a transformer, for converting the DC power to AC power, which provides isolation of control unit 120 from power source 6. Isolation circuit 128 may also include a converter that converts the AC power back to DC power at a voltage level suitable for the components of control unit 120. Accordingly, isolation circuit 128 preferably achieves isolation up to 7500 V.

Input unit 124 provides programmable settings for microcontroller 122, and may take the form of one or more pre-settable switches, such as dual in-line package (DIP) switches. The switches are used to program microcontroller 122 with operating zone data (i.e., threshold current levels and associated time delays), which is described in detail below. It is contemplated that input unit 124 may be used to select the threshold current levels and associated time delays from a range of different values depending upon the application for circuit protection device 10. Input unit 124 may also include a user-activated switch to instruct microcontroller 122 to activate a continuity test function, which will also be described below.

It should be appreciated that alternative means may be used to program settings for microcontroller 122. For example, a fiber optic cable may be connected with an input port (not shown) associated with microcontroller 122, thereby allowing an external computer to program settings for microcontroller 122. It is also contemplated that a wireless communication link could be established with microcontroller 122.

Data converter 126 receives a signal from current sensing device 90 that is indicative of the current through dual path fuse 20. For example, the signal may be the (positive of negative) voltage developed across a current shunt resistor or the output of a Hall Effect current sensor. Data converter 126 converts an analog signal to a digital value indicative of the current through dual path fuse 20. This digital value is communicated to microcontroller 122.

In the illustrated embodiment, output control 130 is comprised of switching means for outputting control signals. The control signals may include, but are not limited to: (1) an activation signal that is received by power disconnect device 40 to activate pyrotechnic unit 45 to sever conductor strip 50; (2) a trigger output signal that is received by a remote device (not shown); and (3) a trigger input signal that is received by microcontroller 122. In one embodiment of the present invention, the switching means is comprised of a plurality of transistors that are turned on through an opto-coupler.

When circuit protection device 10 is placed in a circuit path with a load, virtually all of the current flowing through dual path fuse 20 flows through the first current path (A) defined by conductor strip 50, due to the inherent resistance of the second current path (B) defined by fuse element 80. One function of control unit 120 is to monitor the current flowing through dual path fuse 20, and determine whether a preset threshold current level has been reached or exceeded for a period of time that is equal to, or greater than, an associated time delay. If the current flowing through dual path fuse 20 has reached or exceeded the preset current threshold level for a period of time equal to, or greater than, the associated time delay, control unit 120 activates power disconnect device 40 to sever conductor strip 50, thereby opening first current path (A). As a result, current flowing through dual path fuse 20 is shunted to second current path (B), and will flow therethrough until second current path (B) opens due to the melting of fuse element 80.

The operation of control unit 120 will be now be described in detail. As indicated above, microcontroller 122 is programmed with operating zone data, i.e., threshold current levels and associated time delays. Each preset threshold current level establishes a zone comprised of a range of current levels. Each zone also has an associated time delay. In the illustrated embodiment, each preset threshold current level is the lower limit of a range. Preset threshold current levels above the lowest preset threshold current level establish additional zones having different associated time delays, as will be illustrated below. Current levels below the lowest preset threshold current level are not indicative of an overcurrent condition. In summary, the operating zone data is used to establish multiple ranges of current values, wherein each range of current values is associated with a different time delay. Therefore, the time delay for actuation of power disconnect device 40 is dependent upon which range of current values a detected current falls within.

Current sensing device 90, located in the current carrying path, is used to sense the current flowing through dual path fuse 20 (referred to hereinafter as “the sensed current”). Microcontroller 122 continuously monitors the sensed current and compares the sensed current to the preset threshold current levels that are programmed into microcontroller 122 using input unit 124. Accordingly, microcontroller 122 determines which zone the sensed current falls within. If the sensed current reaches a level where it falls within a zone, microcontroller 122 initiates an internal timer associated with that zone. The timer allows microcontroller 122 to determine whether a time delay has elapsed. Microcontroller 122 initiates a separate timer for each zone.

If microcontroller 122 determines that the sensed current has been at a current level within a zone for a period of time that is equal to, or greater than, the time delay associated with that zone, microcontroller 122 transmits an ON signal to output control 130 to cause activation of power disconnect device 40. In response to the ON signal, output control 130 outputs an activation signal to power disconnect device 40, thereby causing pyrotechnic unit 45 to sever conductor strip 50.

If microcontroller 122 determines that the sensed current has not been at a current level within a zone for a period of time equal to, or greater than, the time delay associated with the zone, then microcontroller 122 resets the timer and continues to monitor the sensed current for an overcurrent condition. As indicated above, current levels below the lowest preset threshold current level do not present an overcurrent condition.

According to one embodiment of the present invention, a timer for a zone will continue timer operations even when the sensed current has increased beyond that zone to a level associated with a zone having a higher range of current levels. Therefore, multiple timers may operate concurrently. The first timer to reach its associated time delay will cause microcontroller 122 to transmit the ON signal to output control 130, thereby causing activation of power disconnect device 40.

In one embodiment of the present invention, the ON signal received by output control 130 turns on a first transistor switch. Turning on the first transistor switch allows current to flow through an actuator (not shown) of the explosive charge igniter of pyrotechnic unit 45. Consequently, an explosive charge is ignited to drive movement of the piston of pyrotechnic unit 45, thereby severing conductor strip 50. The ON signal transmitted by microcontroller 122 to output control 130 may also cause output control 130 to output a trigger output signal for triggering another device, as will be discussed below. In one embodiment, the trigger output signal is generated by turning on a second transistor switch.

As discussed above, output control 130 may also receive a trigger input signal. The trigger input signal may be manually input by user in response to a user-defined condition or it may be generated by operation of another device. When output control 130 receives a trigger input signal, output control 130 transmits a signal to microcontroller 122 that causes microcontroller 122 to transmit the ON signal discussed above. In this manner, a user or a remote device can cause microcontroller 122 to activate power disconnect device 40.

When the first current path (A) (defined by conductor strip 50) opens, current flows through the second current path (B) (defined by fuse element 80). Parallel fuse element 80 is constructed such that for the maximum current the components of parallel fuse element 80 will melt slowly enough that there is sufficient time to allow the region around conductor strip 50 to de-ionize. If the components of parallel fuse element 80 melt too quickly, the circuit voltage will be applied across an ionized area, the area may conduct current again, and a catastrophic failure may occur.

As indicated above, input unit 124 may include a user-activated switch to instruct microcontroller 122 to activate a test function for performing a continuity test on the actuator of the explosive charge igniter and connections to it. Microcontroller 122 responds to activation of the test function by sending a continuity test signal to output control 130. Output control 130 responds to the continuity test signal by allowing a low level current to flow to the actuator of the explosive charge igniter of pyrotechnic unit 45. The low level current is substantially below the current level required to cause activation of the actuator, but sufficient to determine continuity of the explosive charge igniter. The outcome of the continuity test may be displayed to the user, for example, by illumination of a light emitting diode (not shown).

The operation of circuit protection device 10 will now be further described by way of an example. In this example, current sensing device 90 is a current shunt resistor rated at 400 A/100 mV and microcontroller 122 is programmed with three different preset threshold current levels and associated time delays, thereby providing three (3) operating zones for circuit protection device 10, as follows:

Zone A

Threshold Current Level: 540 Amps (135 mV)

Time Delay: 5 seconds

Zone B

Threshold Current Level: 1000 Amps (250 mV)

Time Delay: 0.2 seconds

Zone C

Threshold Current Level: 3000 Amps (750 mV)

Time Delay: 0.01 seconds

In this example, when the sensed current is in a range of 540 A to 999 A (Zone A), microcontroller 122 will activate power disconnect device 40 after a time delay of 5 seconds. When the sensed current is in a range of 1000 A to 2999 A (Zone B), microcontroller 122 will activate power disconnect device 40 after a time delay of 0.01 seconds. Moreover, when the sensed current is in a range of 3000 A (Zone C), microcontroller 122 will activate power disconnect device 40 after a time delay of 0.01 seconds (virtually instantaneous).

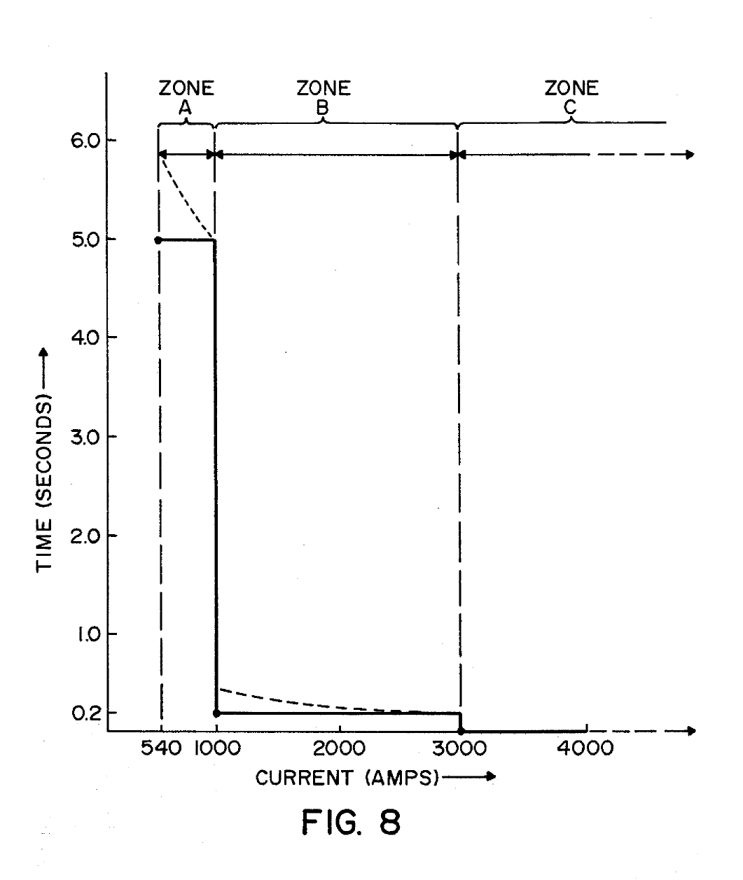

The stepped solid line shown in FIG. 8 illustrates the response times associated with multiple operating zones A, B and C. The dashed line of FIG. 8 shows the total response time for activation of circuit protection device 10. Excluding the response time of control unit 120, the total response time for activation of circuit protection device 10 is defined by the preset time delay (for the respective zone) plus the melt time and arcing time for fuse element 80.

It should be appreciated that the use of multiple threshold current levels and associated time delays in the present invention overcomes problems that occur when there is only one threshold current level and associated time delay. In this respect; if the time delay for the single threshold current level is set too short, then harmless overload conditions will trigger activation of the circuit protection device, thereby requiring frequent replacement of the fuse element. Alternatively, if the time delay for the single threshold current level is set too long, then a catastrophic event will occur, and the circuit protection device 10 will fail. In accordance with the present invention, a relatively long time delay can be associated with lower current levels, while a shorter time delay can be associated with higher current levels. Therefore, activation of the circuit protection device will be avoided for harmless overload conditions, while still triggering activation of the circuit protection device in response to dangerous overcurrent conditions. The multiple operating zones of the present invention prevents conductor strip 50 from melting before it is severed by activation of power disconnect device 40.

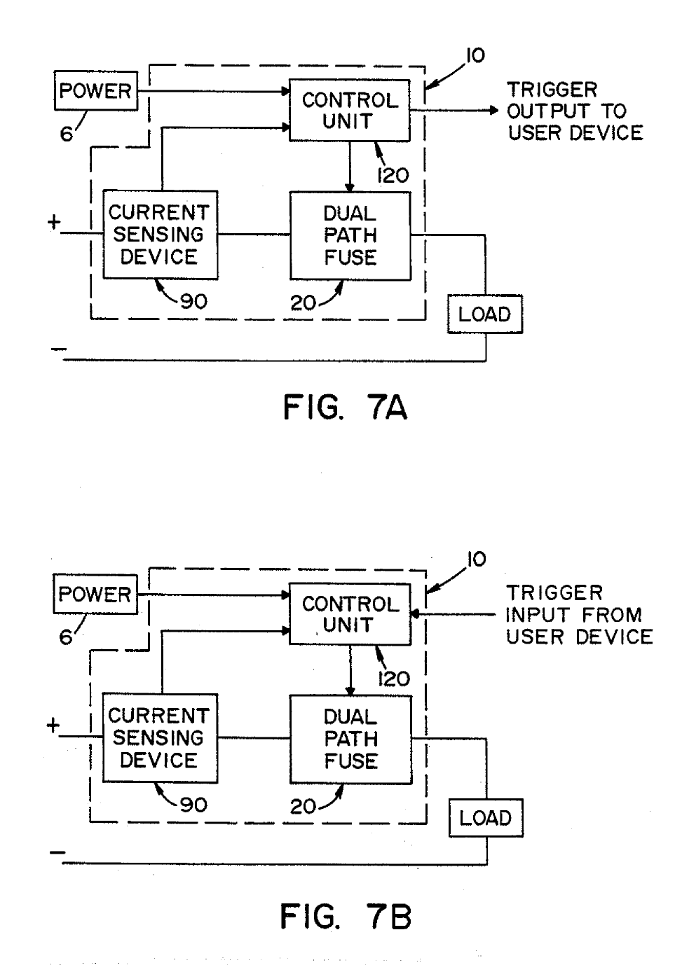

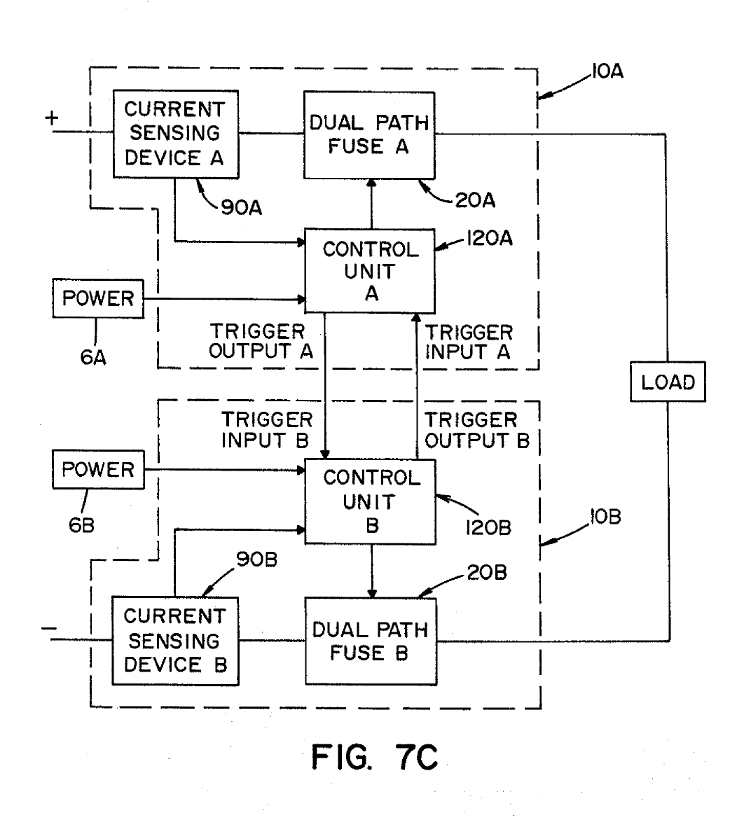

Examples of circuit arrangements including circuit protection device 10 are shown in FIGS. 7A-7C. FIG. 7A illustrates a circuit arrangement wherein control unit 120 provides a trigger output to one or more devices in other circuit(s), in response to an overcurrent condition. FIG. 7B illustrates a circuit arrangement wherein control unit 120 receives a trigger input from a user or device in another circuit. FIG. 7C illustrates a circuit arrangement wherein a pair of circuit protection devices 10A and 10B are connected to each other. Circuit protection device 10A is comprised of a dual path fuse 20A, a current sensing device 90A and a control unit 120A. Power is supplied to circuit protection device 10A by a power source 6A. Similarly, circuit protection device 10B is comprised of a dual path fuse 20B, a current sensing device 90B and a control unit 120B. Power is supplied to circuit protection device 10B by a power source 6B. Trigger output A is received as a trigger input at control unit 120B, while trigger output B is received as a trigger input at control unit 120A. With this arrangement, activation of circuit protection device 10A will cause activation of circuit protection device 10B, and vice versa. Accordingly, both the positive and negative legs of the circuit are opened in response to an overcurrent condition.

Other modifications and alterations will occur to others upon their reading and understanding of the specification. For example, although the present invention has been described with reference to use with photovoltaic systems, it is contemplated that the present invention may find utility in connection with other types of electrical systems. It is intended that all such modifications and alterations be included insofar as they come within the scope of the invention as claimed or the equivalents thereof.

Having described the invention, the following is claimed:

1. A circuit protection device comprising:
a dual path fuse including a main conductor defining a first current path and a fuse element defining a second current path;
a power disconnect device for severing the main conductor to open the first current path, thereby shunting residual follow-on current to the second current path until the fuse element melts;
a control unit responsive to an overcurrent condition of a detected current to activate the power disconnect device to sever to the main conductor, wherein said control unit is programmable with operating zone data that provides different response times for activation of the power disconnect device depending upon a level of the detected current.

2. A circuit protection device according to claim 1, wherein operating zone data includes a plurality of threshold current levels and associated activation time delays.

3. A circuit protection device according to claim 2, wherein said plurality of threshold current levels establish ranges of current levels that are associated with different activation time delays.

4. A circuit protection device according to claim 2, wherein said control unit includes a timer for determining whether a time delay has elapsed.

5. A circuit protection device according to claim 1, wherein said circuit protection device further comprises:
a current sensing device for providing the control unit with a signal indicative of the level of the detected current.

6. A circuit protection device according to claim 5, wherein said current sensing device is a current shunt resistor or a Hall Effect current sensor.

7. A circuit protection device according to claim 1, wherein said power disconnect device includes a pyrotechnic unit.

8. A circuit protection device according to claim 1, wherein said fuse element is comprised of at least one conducting element having notches formed therein.

9. A circuit protection device according to claim 1, wherein said control unit is responsive to a trigger input signal to activate said power disconnect device.

10. A method for protecting a circuit from an overcurrent condition by activation of a circuit protection device that opens a circuit path in said circuit, said method comprising:
establishing a plurality of threshold current levels defining multiple current level ranges;
establishing a plurality of activation time delays respectively associated with the multiple current level ranges;
monitoring a detected current in the circuit;
determining whether the detected current is at a current level within one of said multiple current level ranges;
activating the circuit protection device to open the circuit path of said circuit if the detected current level is at the current level within one of said multiple current level ranges for a period of time that is equal to or greater than the activation time delay associated therewith.

11. A method according to claim 10, wherein activation of said circuit protection device causes a pyrotechnic unit to sever a conductor.

12. A method according to claim 10, wherein said circuit protection device includes a pair of parallel current paths.

13. A dual path fuse comprising:
a main conductor defining a first current path;
a fuse element defining a second current path; and
a power disconnect device responsive to an activation signal to sever the main conductor and thereby open the first current path, wherein said power disconnect device receives the activation signal from a control unit that responds to an overcurrent condition of a detected current, said control unit programmable with operating zone data that provides different delay times for generating the activation signal depending upon a level of the detected current.

14. A circuit protection device according to claim 13, wherein operating zone data includes a plurality of threshold current levels and associated activation time delays.

15. A circuit protection device according to claim 14, wherein said plurality of threshold current levels establish ranges of current levels that are associated with different activation time delays.

16. A circuit protection device according to claim 14, wherein said control unit includes a timer for determining whether an activation time delay has elapsed.

17. A circuit protection device according to claim 13, wherein said circuit protection device further comprises:
a current sensing device for providing the control unit with a signal indicative of the level of the detected current.

18. A circuit protection device according to claim 17, wherein said current sensing device is a current shunt resistor or a Hall Effect current sensor.

19. A circuit protection device according to claim 13, wherein said power disconnect device includes a pyrotechnic unit.
